(19) United States
(12) Patent Application Publication
(10) Pub. No.: US 2013/0191552 A1
(43) Pub. Date: Jul. 25, 2013

(54) METHODS AND SYSTEMS FOR MAPPING FLOW PATHS IN COMPUTER NETWORKS

(71) Applicants: Michael A. Patterson, Sanford, ME (US); Erik Robert Peterson, Scarborough, ME (US); Michael J. Krygeris, Somersworth, NH (US)

(72) Inventors: Michael A. Patterson, Sanford, ME (US); Erik Robert Peterson, Scarborough, ME (US); Michael J. Krygeris, Somersworth, NH (US)

(73) Assignee: PLIXER INTERNATIONAL, Sanford, ME (US)

(21) Appl. No.: 13/355,490

(22) Filed: Jan. 21, 2012

(51) Int. Cl. G06F 15/173

(52) U.S. Cl. 709/241

(57) ABSTRACT

Methods and systems are provided for determining a flow path for a flow between a source host and a destination host on a computer network wherein the flow has a tuple associated therewith. In one embodiment, a method comprises receiving flow data from exporters on the network, finding one or more exporters that possibly carry the flow, and using the flow data to determine whether any of the one or more exporters that possibly carry the flow include the tuple. For any exporters that include the tuple, the flow data is used to determine a next hop for such exporter. Connection pairs are created between each exporter that includes the tuple and its next hop. The connection pairs are combined to define the flow path.

### BACKGROUND OF THE INVENTION

This invention relates generally to computer networks and more particularly to mapping flow paths in computer networks.

Computer networks have become a vital mode of telecommunication, allowing individuals and businesses to rapidly access and share information. Generally, a computer network can comprise a number of hosts (including server and client computers) connected by various network devices such as routers, firewalls, switches and the like. One common mode of network communication is packet switching technology in which all of the data being transmitted is grouped into small blocks called data packets. Communications between hosts on a packet switching network comprise “flows,” wherein a “flow” refers to an aggregation of data packets transmitted from a source to a destination. The data packets of a given flow share a set of common properties or values, which typically include the source IP address, the source port, the destination IP address, the destination port, the protocol and time. A network flow can be identified by this set of values, which is referred to as the tuple, wherein each flow has a unique tuple associated with it.

Several network traffic monitoring technologies (i.e., tools for collecting, reporting and analyzing flow information) have been developed to assist network administrators in assessing network performance. Examples of such network traffic monitoring technologies include NetFlow, IPFIX, Jflow, NetStream and AppFlow. In these technologies, the network devices (routers, switches, firewalls, etc.) are configured to electronically generate information about the data packets passing though the network device. Such electronic information is referred to herein as “flow data.” Network devices that are enabled to gather and export flow data are commonly referred to as “exporters.” The flow data from the exporters are sent to a collector, which aggregates the flow data and generates reports for analysis.

When two hosts communicate over a network, the data packets typically pass through several network devices to get from the source to the destination. The passage of a flow from one network device to the next is referred to as a “hop,” and the “next hop” with respect to a given network device refers to the next network device the flow will travel through to reach the destination. There typically are multiple paths through the various network devices a flow can take between the hosts, and a different path can be taken each time the two hosts communicate. This presents difficulties for network administrators in diagnosing problems that occur from time to time. Existing tools that assist network administrators in determining the flow path when network degradation problems occur provide the likely path based on Simple Network Management Protocol (SNMP) or by using proprietary synthetic information. However, these tools provide only the likely path, which is not always the actual path, especially where several possible paths exist.

Accordingly, there is a need for a tool for accurately and reliably determining network flow paths.

### SUMMARY OF THE INVENTION

The above-mentioned need is met by the present invention, which provides methods and systems for determining a flow path for a flow between a source host and a destination host on a computer network wherein the flow has a tuple associated therewith. In one embodiment, a method comprises receiving flow data from exporters on the network, finding one or more exporters that possibly carry the flow, and using the flow data to determine whether any of the one or more exporters that possibly carry the flow include the tuple. For any exporters that include the tuple, the flow data is used to determine a next hop for such exporter. Connection pairs are created between each exporter that includes the tuple and its next hop. The connection pairs are combined to define the flow path.

### DESCRIPTION OF THE DRAWINGS

FIG. 1 is a block diagram of a portion of an exemplary computer network on which the present invention is implemented.

FIG. 2 is a block diagram of the flow monitor from FIG. 1.

FIG. 3 is a flowchart depicting a flow mapping process.

FIG. 4 is a representation of a screen display showing a sample map of the flow path between two hosts.

FIG. 5 is a representation of a screen display showing a sample data table corresponding to a middlebox.

FIG. 6 is a flowchart depicting a process for creating strings of connection pairs.

### DETAILED DESCRIPTION OF THE INVENTION

The present invention relates to a computer-based tool or utility for determining the path of a flow between two communicating hosts which are separated by exporters. The tool mines flow data collected from the network exporters and uses this data to map the actual path a flow took across the network to the extent possible. Rather than use synthetic transactions or rely solely on device configuration information, the tool provides a graphical map of the flow path based on original, actual data.

The map can be displayed as a graphical user interface, which can be used to determine the source of a connection performance problem (i.e., degradation) when communication between the hosts becomes poor. The tool also provides flow details for each hop including flow changes made by exporters in the path. Hyperlinks for each exporter are created for the map display to allow users to drill-in and access the flow details.

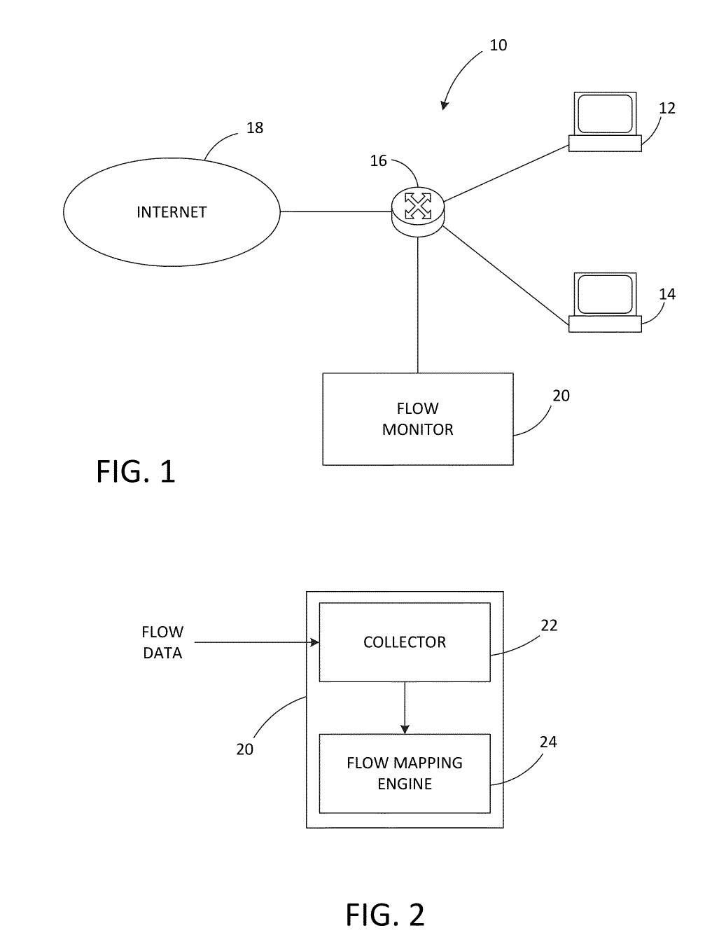

Referring to the drawings wherein identical reference numerals denote the same elements throughout the various views, FIG. 1 shows a portion of an exemplary computer network 10 with which the present invention can be implemented. First and second hosts 12 and 14 are connected to a router 16. Each host 12 and 14 has a unique IP address. The router 16, which can also be connected to the Internet 18, provides a “traffic directing” function by reading the address information of incoming data packets and forwarding the data packets accordingly. The hosts 12 and 14 thus can communicate with each other and the Internet 18 via the router 16.

The router 16 is an exporter that has network traffic monitoring technology (such as NetFlow, IPFIX, Jflow, NetStream and AppFlow) so as to be capable of gathering and exporting flow data about the data packets passing through the router 16. The flow data gathered by the router 16 include the standard tuple values (i.e., source IP address, the source port, the destination IP address, the destination port, the protocol and time) for the data packets. The flow data gathered by the router 16 also includes the next hop IP address. The router 16 exports its flow data to a flow monitor 20 connected to the router 16 via any suitable communications link. As will be described in more detail below, the flow monitor 20 uses the flow data to determine flow paths between communicating hosts in addition to producing conventional flow monitoring reports.

The configuration of the computer network 10 depicted in FIG. 1 is shown only for purposes of illustration; a wide variety of network configurations are possible. While only two hosts and one router are depicted in FIG. 1 for the sake of convenience, it should be noted that several additional hosts and routers, as well other network devices (such as switches, firewalls, and the like), typically would be included. The flow monitor 20 typically will be set up to receive flow data exported from several routers and other network devices on the network 10.

Turning to FIG. 2, one embodiment of the flow monitor 20 is shown in more detail. The flow monitor 20 is broken down into two functions: a collector 22 and a flow mapping engine 24. The collector 22 receives the flow data exported from the router 16 (and all other exporters on the network), aggregates the flow data and puts it in a database for monitoring network activity. In this respect, the collector 22 provides a conventional network traffic monitoring function. In addition, and in accordance with an aspect of the present invention, the collector 22 outputs the flow data to the flow mapping engine 24. The flow mapping engine 24 is the tool for determining flow paths between hosts (such as hosts 12 and 14) on the network.

The flow monitor 20 is implemented on a computer system. Generally, the computer system will include a processor, system memory and one or more storage devices for storing data and software. The flow monitor 20 will typically reside on one or more computer readable media such as hard disks, floppy disks, optical disks such as a CD-ROMs or other optical media, magnetic tapes, flash memory cards, integrated circuit memory devices (e.g., EEPROM), and the like. As used herein, the term “computer readable medium” refers generally to any medium from which stored data can be read by a computer or similar unit. A “non-transitory computer readable medium” refers to any computer readable medium excluding transitory media such as transitory signals.

It should be noted that the flow monitor 20 could be implemented on a computer system comprising a single computer device such as a server computer. Alternatively, the flow monitor 20 could be implemented on a computer system comprising multiple computers linked together though a communications network. For instance, the collector 22 could reside on a first computing device and the flow mapping engine 24 could reside on a second computing device. Thus, as used herein, the term “computer system” encompasses not only a single, standalone computer but also two or more computers linked together via a communications network.

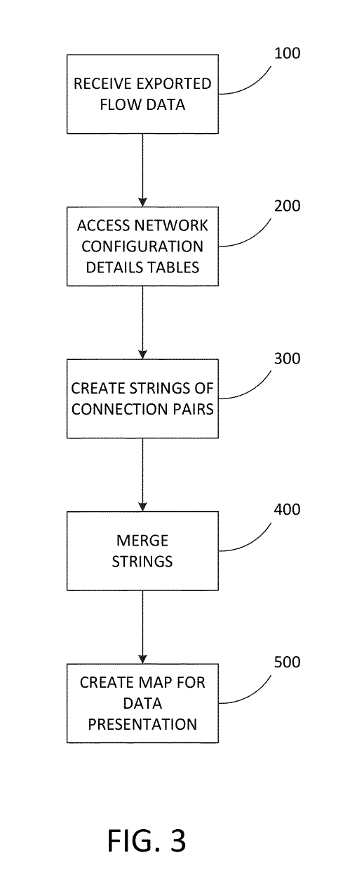

FIG. 3 is a flowchart showing the operation of the flow mapping engine 24. The flow path mapping process begins at block 100 where the flow mapping engine 24 receives the exported flow data from the collector 22 and stores it in historical flow data tables. As mentioned above, the flow data includes the tuple for each flow as well as the next hop IP addresses. At block 200, the flow mapping engine 24 accesses a series of tables collectively known as the network configuration details tables. These tables are generated periodically (e.g., daily) by using SNMP or another method to gather routing data and interface IP addresses on each exporter.

The flow mapping engine 24 then uses the flow tuple combined with information from the network configuration details tables and historical flow data tables to create strings of connection pairs at block 300. That is, the flow mapping engine 24 tries to find all of the exporters in the flow between the source and destination based on the tuple associated with the flow and also determines the order of connectivity of the exporters, wherein two devices (hosts or exporters) in direct flow relationship make up a connection pair. For instance, an exporter and its next hop would be a connection pair because the flow travels from the exporter directly to its next hop. As described in more detail below, this step is carried out in a forward direction (i.e., from the source to the destination) to identify forward strings and in a reverse direction (i.e., from the destination to the source) to identify reverse strings.

Next, at block 400, the forward strings are merged to identify the forward path, and the reverse strings are merged to identify the reverse path, as the forward and reverse paths through a network are not always the same.

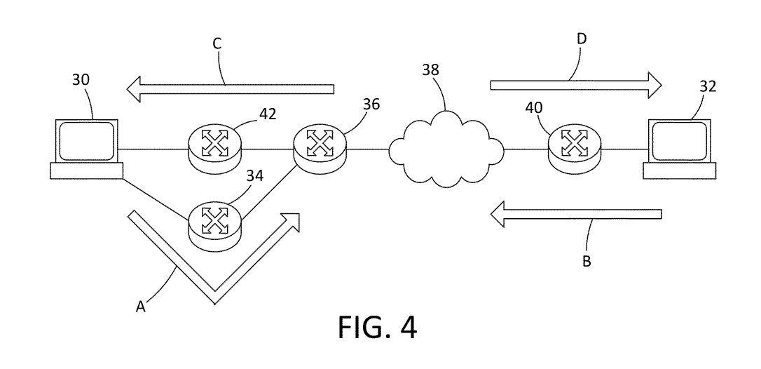

The flow mapping engine 24 then generates suitable software code for displaying a map of the forward and reverse paths in the form of a graphical user interface at block 500. The map includes icons of the source host, the destination host, exporters and clouds (which represent unknown portions of the flow path) and uses links to show the connectivity between these elements. FIG. 4 shows an example of such a map showing the flow paths between a source host 30 and a destination host 32. The forward path travels from the source host 30, through a first router 34, a second router 36, an unknown portion (which can comprise one or more non-exporting network devices) represented by a cloud 38, a third router 40, and then to the destination host 32. The reverse path travels from the destination host 32, through the third router 40, the cloud 38, the second router 36, a fourth router 42, and then to the source host 30. The flow mapping engine 24 calculates map positions for the icons to create a useful layout when displayed. The links can be color-coded to distinguish between the forward path and the reverse path.

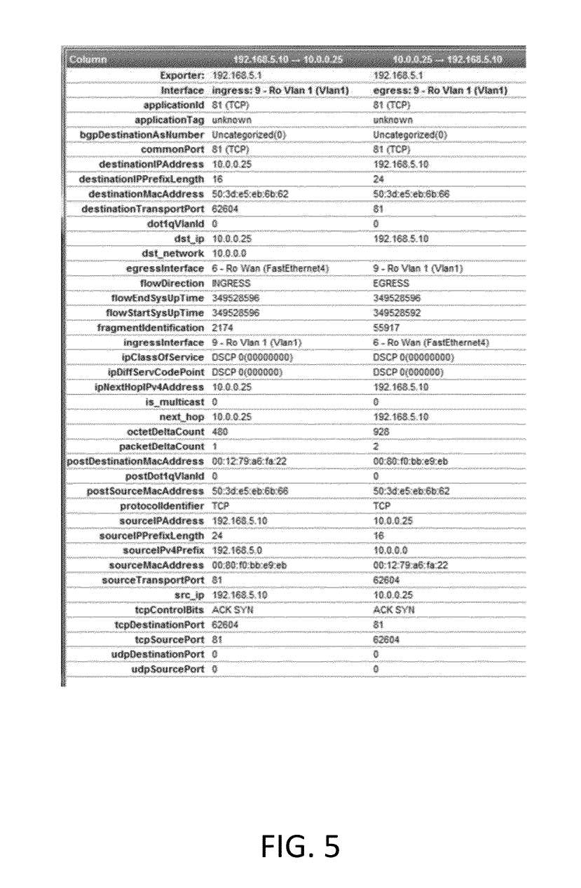

The flow mapping engine 24 also generates hyperlinks that are displayed on the map and associated with each of the icons. These hyperlinks allow a user to click on the icon corresponding to an exporter of interest which launches a data table containing flow details for the exporter. An example of such a data table is shown in FIG. 5. In the case where the exporter is a “middlebox” (i.e., an exporter capable of altering the flow) the data table will highlight changes between the ingress and egress, as is depicted in FIG. 5.

The string creating step 300 of FIG. 3 uses up to four checks in an attempt to find every exporter along the flow path. Specifically, the flow mapping engine 24 executes at least two, and as many as four, checks. The first check comprises starting at the source host and then trying to find all the exporters on the way to the destination host. The second check comprises starting at the destination host and then trying to find all the exporters on the way to the source host. If the second check fails to reach the source host, then a third check is executed which comprises looking at all the possible exporters found by the first check and then trying to find all the exporters on the way back to the source host. If the first check fails to reach the destination host, then a fourth check is executed which comprises looking at all the possible exporters found with the second check and then trying to find all the exporters on the way back to the destination host. The third check is not needed if the second check succeeds in finding all the exporters in the flow path from the destination host to the source host and is thus executed only if the second check fails to reach the source host. Similarly, the fourth check is not needed if the first check succeeds in finding all the exporters in the flow path from the source host to the destination host and is thus executed only if the first check fails to reach the destination host.

Referring to the map shown in FIG. 4 as an example, the four checks executed to produce this map proceeded as follows: The first check, as represented by arrow A, began at the source host 30 and found that the flow from the source host 30 went through the router 34 and the router 36, but then reached a dead end (represented by the cloud 38) without reaching the destination host 32. The second check, as represented by arrow B, began at the destination host 32 and found that the flow from the destination host 32 went through the router 40, but then reached a dead end (represented by the cloud 38) without reaching the source host 30. The third check was executed because the second check dead-ended. The third check, represented by arrow C, looked at routers 34, 36 and 42 in no particular order and found that the flow from the router 36 went through the router 42 and then to the source host 30. The third check looked at routers 34, 36 and 42 because these were found to be the possible routers supporting the source host 30 during the first check. The fourth check was executed because the first check dead-ended. The fourth check, represented by arrow D, looked at the router 40 and found that the flow from the router 40 went to the destination host 32. The fourth check looked at the router 40 because this was found to be the possible router supporting the destination host 32 during the second check.

These four checks resulted in four strings: a first string A from the source host 30, to the router 34, to the router 36 and to the cloud 38; a second string B from the destination source 32, to the router 40 and to the cloud 38; a third string C from the router 36, to the router 42 and to the source host 30; and a fourth string D from the router 40 to the destination host 32. The string merging step 400 of FIG. 3 merges the first and fourth strings to define the forward path from the source host 30, to the router 34, to the router 36 to the cloud 38, to the router 40, and to the destination host 32. In addition, the second and third strings are merged to define the reverse path from the destination host 32, to the router 40, to the cloud 38, to the router 36, to the router 42, and to the source host 30.

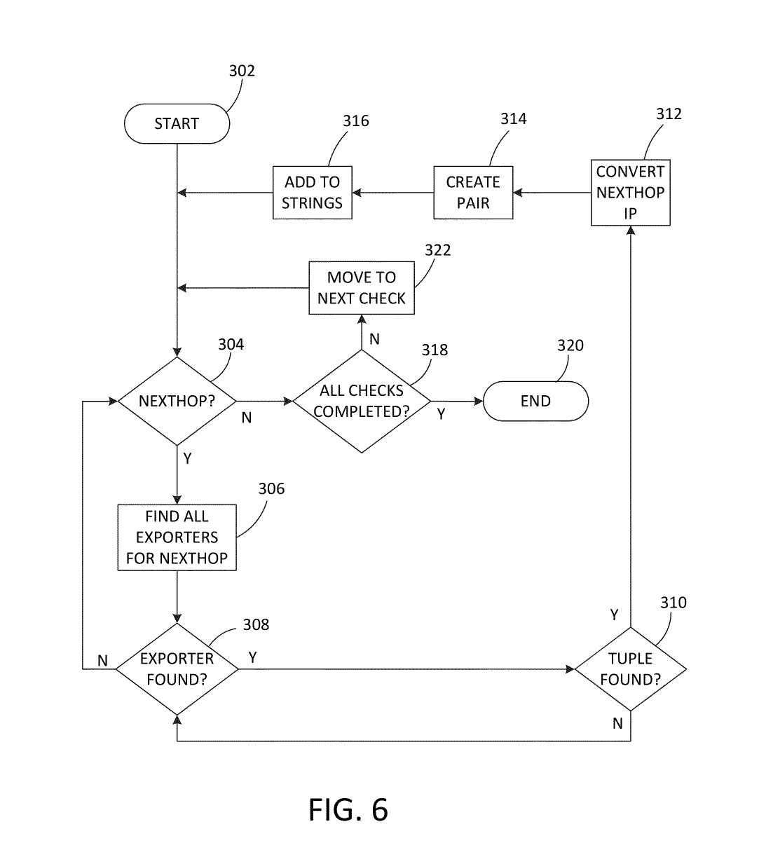

Turning to FIG. 6, a flowchart depicting the string creating step 300 of FIG. 3 in more detail is shown. Generally, the string creating process executes each of the four checks, if needed. It should be noted that while the checks are referred to herein as “first,” “second,” third,” and “fourth” this designation is not indicative of any particular order of execution. The checks can be carried out in any order other than the first and second checks will precede the third and fourth checks. The string creating process starts at block 302 with the initiation of the first check (although, as noted above, the process could also begin with the second check). At block 304, the flow mapping engine 24 determines whether a next hop is available. For the purpose of initiating a check, the starting point of the check is initially designated as the next hop. Thus, the source host is initially designated as the next hop for the first check, and the destination host is initially designated as the next hop for the second check. The initial next hops for the third and fourth checks will be exporters found during the first and second checks, respectively, as described in more detail below. Subsequent next hops for the check, if any, are identified in the manner described below.

If a next hop is available, then the process moves to block 306 where the flow mapping engine 24 finds the exporters for the next hop, which initially for the first check is the source host. The flow mapping engine 24 finds these exporters by querying the network configuration details tables, which contain routing information as mentioned above. A typical network could have several hundred routers and it would not be feasible to look at each one. Therefore, the flow mapping engine 24 limits itself to only the exporters relevant to the next hop, such as the exporters that support the next hop's subnet.

At block 308, if an exporter is not found, then the process goes back to block 304 where the flow mapping engine 24 can determine if there are any other next hops. If an exporter is found at block 308, then the process moves to block 310 where the flow mapping engine 24 queries the historical flow data tables to determine if the tuple associated with the flow together with the IP address of the exporter's next hop can be found in the flow data for the exporter. If the exporter does not include the tuple, then this indicates that the flow does not pass through this particular exporter. The process then goes back to block 308 to determine if there are any other exporters found for the current next hop. If the tuple and the next hop IP address are found at block 310, this indicates that the flow does pass through the exporter and what that exporter's next hop is. Consequently, the flow mapping engine 24 converts the next hop IP address to its exporter IP address at block 312 using the network configuration details tables while adding the found next hop to the queue that is queried by the flow mapping engine 24 at block 304. The IP address conversion is done because the IP address of the next hop interface is not necessarily the same IP address that the collector 22 recognizes for that exporter. Next, the flow mapping engine 24 creates a connection pair between the exporter and the next hop at block 314 and saves this connection pair to the string at block 316.

At this point, the process returns to block 304 to again determine whether a next hop is available. If a subsequent next hop has been added to the queue at block 312, then the flow mapping engine 24 will determine that the next hop is available and the process will again move to block 306 and proceed as described above. If a next hop is not available at block 304, this indicates that the current check has reached a dead end. The process then moves to block 318 and the flow mapping engine 24 determines if all of the other checks have been executed at block 308. If all of the four checks have been executed (or determined to be unnecessary), then the string creating step 300 is finished and the process ends at block 320 (at which point the mapping process moves on to the string merging step 400 of FIG. 3). If further checks need to be executed, then the flow mapping engine 24 moves to the next check at block 322, and the process begins again for the next check at block 304 and proceeds from there in the same manner as described above. As mentioned above, the source host is initially designated as the next hop when initiating the first check and the destination host is initially designated as the next hop for the second check. The initial next hop(s) for the third check will be the exporter(s) that possibly support the source host found and added to the queue during the first check. The initial next hop(s) for the fourth check will be the exporter(s) that possibly support the destination host found and added to the queue during the second check.

While specific embodiments of the present invention have been described, it should be noted that various modifications thereto can be made without departing from the spirit and scope of the invention as defined in the appended claims.

What is claimed is:

1. A method of determining a flow path for a flow between a source host and a destination host on a computer network wherein said flow has a tuple associated therewith, said method comprising:
receiving flow data from exporters on said network;
finding one or more exporters that possibly carry said flow;
using said flow data to determine whether any of said one or more exporters that possibly carry said flow include said tuple;
for any exporters that include said tuple, using said flow data to determine a next hop for such exporter;
creating connection pairs between each exporter that includes said tuple and its next hop;
combining said connection pairs to define said flow path.

2. The method of claim 1 wherein the step of finding one or more exporters that possibly carry said flow comprises querying one or more tables containing routing data.

3. The method of claim 1 wherein the step of finding one or more exporters that possibly carry said flow comprises finding one or more exporters that support said source host and subsequently finding one or more exporters that support found next hops and continuing until a dead end is reached or all exporters carrying said flow from said source host to said destination host are found.

4. The method of claim 3 wherein if a dead end is reached before finding all exporters carrying said flow from said source host to said destination host are found, further comprising finding exporters that carry flow to said destination host.

5. The method of claim 3 wherein the step of finding one or more exporters that possibly carry said flow further comprises finding one or more exporters that support said destination host and subsequently finding one or more exporters that support found next hops and continuing until a dead end is reached or all exporters carrying said flow from said destination host to said source host are found.

6. The method of claim 5 wherein if a dead end is reached before finding all exporters carrying said flow from said destination host to said source host are found, further comprising finding exporters that carry flow to said source host.

7. The method of claim 1 further comprising displaying a map of said flow path.

8. The method of claim 7 wherein displaying a map of said flow path includes generating code for displaying said map in the form of a graphical user interface.

9. The method of claim 8 wherein said graphical user interface includes icons representing exporters and hyperlinks that launch data tables corresponding to said exporters.

10. The method of claim 9 wherein said data tables can highlight changes in ingress and egress data for an exporter.

11. A non-transitory computer readable medium containing instructions for controlling a computer system to perform a method of determining a flow path for a flow between a source host and a destination host on a computer network wherein said flow has a tuple associated therewith, wherein said method comprises:
receiving flow data from exporters on said network;
finding one or more exporters that possibly carry said flow;
using said flow data to determine whether any of said one or more exporters that possibly carry said flow include said tuple;
for any exporters that include said tuple, using said flow data to determine a next hop for such exporter;
creating connection pairs between each exporter that includes said tuple and its next hop;
combining said connection pairs to define said flow path.

12. The non-transitory computer readable medium of claim 11 wherein the step of finding one or more exporters that possibly carry said flow comprises querying one or more tables containing routing data.

13. The non-transitory computer readable medium of claim 11 wherein the step of finding one or more exporters that possibly carry said flow comprises finding one or more exporters that support said source host and subsequently finding one or more exporters that support found next hops and continuing until a dead end is reached or all exporters carrying said flow from said source host to said destination host are found.

14. The non-transitory computer readable medium of claim 13 wherein if a dead end is reached before finding all exporters carrying said flow from said source host to said destination host are found, finding exporters that carry flow to said destination host.

15. The non-transitory computer readable medium of claim 13 wherein the step of finding one or more exporters that possibly carry said flow further comprises finding one or more exporters that support said destination host and subsequently finding one or more exporters that support found next hops and continuing until a dead end is reached or all exporters carrying said flow from said destination host to said source host are found.

16. The non-transitory computer readable medium of claim 15 wherein if a dead end is reached before finding all exporters carrying said flow from said destination host to said source host are found, finding exporters that carry flow to said source host.

17. The non-transitory computer readable medium of claim 11 wherein in method further comprises displaying a map of said flow path.

18. The non-transitory computer readable medium of claim 17 wherein displaying a map of said flow path includes generating code for displaying said map in the form of a graphical user interface.

19. The non-transitory computer readable medium of claim 18 wherein said graphical user interface includes icons representing exporters and hyperlinks that launch data tables corresponding to said exporters.

20. The non-transitory computer readable medium of claim 19 wherein said data tables can highlight changes in ingress and egress data for an exporter.
